(19) United States
(12) Patent Application Publication
(10) Pub. No.: US 2025/0056101 A1
(43) Pub. Date: Feb. 13, 2025

(54) VIDEO CREATION SYSTEM, VIDEO CREATION DEVICE, AND VIDEO CREATION PROGRAM

(71) Applicants: Masahiro SAKAKIBARA, Kyoto-shi, Kyoto (JP); Masashi KOMOSHITA, Kyoto-shi, Kyoto (JP); REDEFINEARTS INC., Kyoto-shi, Kyoto (JP)

(72) Inventors: Masahiro SAKAKIBARA, Kyoto-shi (JP); Masashi KOMOSHITA, Kyoto-shi (JP)

(73) Assignees: Masahiro SAKAKIBARA, Kyoto-shi, Kyoto (JP); Masashi KOMOSHITA, Kyoto-shi, Kyoto (JP); REDEFINEARTS INC., Kyoto-shi, Kyoto (JP)

(21) Appl. No.: 18/723,661

(22) PCT Filed: Dec. 23, 2022
(86) PCT No.: PCT/JP2022/047566

§ 371 Date: Jun. 24, 2024

(30) Foreign Application Priority Data
Dec. 24, 2021 (JP) 2021-210260

(51) Int. Cl. H04N 21/81; G06T 13/40; G06T 17/00

(52) U.S. Cl. CPC H04N 21/816; G06T 13/40; G06T 17/00

(57) ABSTRACT

A video creation system includes a storage unit to store display data of a virtual space and display data of a character; an action input terminal to allow a user to input an action of the character; a character action controller to read the display data of the character and cause the character to act in the virtual space according to an input to the action input terminal; a shooting position setter to set an entire view position and a character-capturing position; a shooting position selector to receive an input for selecting the entire view position or the character-capturing position as a shooting position; a virtual space imager to generate data of an image obtained by shooting the virtual space at the input shooting position; and a video creator to create data of a video by recording the data of an image obtained by the virtual space imager.

### TECHNICAL FIELD

The present invention relates to a technique of creating a video in which a character acting in a virtual space is captured.

### BACKGROUND

It is widely practiced that many people create a video by shooting themselves dancing or singing and post the video on a video sharing website or an individual page of a social networking service provided on the Internet. When creating such a video, it is common for a person who creates a video to shoot an image in a shooting studio provided at a corner of the person's house.

However, there are limitations on the size of a shooting studio which can be provided at home and the variations in interior. A person, what is called YouTuber, who posts videos as the person's profession may rent a shooting studio suitable for a video every time the person creates a video, but it is time consuming and costly.

In recent years, computer graphics (CG) has been used as a technique capable of solving such a problem. Using CG can set a virtual space simulating an internal space of any shooting studio. In addition, using CG allows any character to appear in the virtual space.

For example, Patent Literature 1 discloses a video creation method in which a CG character appears in a virtual space simulating a studio of a television station and is captured by a virtual camera disposed in the virtual space to create a video (produced video). This video creation method is characterized in that, in addition to the camera for shooting a produced video, another camera for checking the disposition and movement of the CG character is disposed, and images captured by the respective cameras are switchably displayed on a preview screen for editing to finally complete the produced video. As a specific example, Patent Literature 1 describes a configuration of a produced video in which two CG characters are disposed in a virtual space simulating a television studio and images of the two CG characters are captured by a camera located substantially in front of the virtual space.

### PATENT LITERATURE

Patent Literature 1: JP 2001-202531 A

### SUMMARY

In the above example, since only one camera is used to shoot the produced video, the resulting video becomes monotonous with the CG characters captured at a single angle of view, and the viewer gets bored while watching the video. Using a plurality of cameras for shooting a produced video can obtain a plurality of images having different angles of view. However, in order to finally create a single video, it is necessary to check a large number of videos obtained by the plurality of cameras each shooting the virtual space simultaneously and select desired portions and combine them, which takes time and effort.

An object of the present invention is to provide a technique which enables easy creation of a video in which a character acting in a virtual space is captured and which does not make a viewer get bored.

The present invention made to solve the above problems is a system for creating a video of a character acting in a virtual space, the system including:
a storage unit configured to store display data of a virtual space and display data of a character;
an action input terminal configured to allow a user to input an action of the character;
a character action controller configured to read the display data of the character from the storage unit and cause the character to act in the virtual space according to the action of the character input to the action input terminal;
a shooting position setter configured to set an entire view position at which an entire view of the virtual space is captured and a character-capturing position at which the character in the virtual space is captured at a predetermined angle of view;
a shooting position selector configured to receive an input for selecting the entire view position or the character-capturing position as a shooting position;
a virtual space imager configured to generate data of an image obtained by shooting the virtual space with a virtual camera at the shooting position input to the shooting position selector; and a video creator configured to create data of a video by sequentially recording the data of images obtained by the virtual space imager.

The virtual space may be a space simulating a real space or a non-real space. In addition, the character may be a character imitating a famous person such as an actor or an idle who actually exists, or may be a non-existent character. Furthermore, the character may be other than a human, such as an animal, a robot, or various personified objects.

In addition, as the action input terminal, for example, a motion capture, a controller in which a relationship between an action of a character and a button is defined in advance, or the like can be used.

Furthermore, the data of an image or a video is not limited only to that stored as an image file format or a video file format. For example, the data of an image or a video may be data that is constructed by parameters necessary for reconstructing an image or a video associated with each other, such as display data of a virtual space, data of position information and posture information of a character in the virtual space, and information of a shooting position selected at the time.

In the video creation system according to the present invention, for example, a director, i.e. a person who creates a video, can create various videos such as a movie, a drama, and an advertisement video on the basis of a previously prepared script and scenario. In creating such a video, for example, a real actor inputs by oneself actions of a character imitating the actor to the action input terminal to make the character act in the virtual space. When the character starts action, the director selects the entire view position or the character-capturing position which most effectively captures the action of the character by inputting to the shooting position selector. The virtual space imager generates data of an image obtained by shooting the virtual space at the input position, and in response to this, the video creator creates data of images in which the image data is sequentially recorded. According to the present invention, it is possible for a user such as a director to easily create a video constructed by images in which a character acting in a virtual space is captured at different angles of view only by inputting a selection of a shooting position at an appropriate timing during shooting.

Another mode of the present invention made to solve the above problems is a device for creating a video of a character acting in a virtual space, the device connectable to an action input terminal configured to allow a user to input an action of the character, the device including:
a storage unit configured to store display data of a virtual space and display data of a character;
a character action controller configured to read the display data of the character from the storage unit and cause the character to act in the virtual space according to the action of the character input to the action input terminal;
a shooting position setter configured to set an entire view position at which an entire view of the virtual space is captured and a character-capturing position at which the character in the virtual space is captured at a predetermined angle of view;
a shooting position selector configured to receive an input for selecting the entire view position or the character-capturing position as a shooting position;
a virtual space imager configured to generate data of an image obtained by shooting the virtual space with a virtual camera at the shooting position input to the shooting position selector; and a video creator configured to create data of a video by sequentially recording the data of images obtained by the virtual space imager.

Yet another mode of the present invention made to solve the above problems is a video creation program for creating a video of a character acting in a virtual space, the video creation program configured to cause a computer connectable to an action input terminal configured to allow a user to input an action of the character and including a storage unit configured to store display data of the virtual space and display data of the character to operate as:
a character action controller configured to read display data of a character from the storage unit and cause the character to act in a virtual space according to the action of the character input to the action input terminal;
a shooting position setter configured to set an entire view position at which an entire view of the virtual space is captured and a character-capturing position at which the character in the virtual space is captured at a predetermined angle of view;
a shooting position selector configured to receive an input for selecting the entire view position or the character-capturing position as a shooting position;
a virtual space imager configured to generate data of an image obtained by shooting the virtual space with a virtual camera at the shooting position input to the shooting position selector; and
a video creator configured to create data of a video by sequentially recording the data of images obtained by the virtual space imager.

Preferably, the video creation system, the video creation device, or the video creation program according to the present invention further includes a shooting image display unit configured to display an image of the virtual space captured by the virtual camera at the entire view position and an image of the virtual space captured by the virtual camera at the character-capturing position.

The video creation system, the video creation device, or the video creation program according to the mode including the shooting image display unit enables a person who creates a video to select the shooting position while checking the image in which the virtual space is being captured.

Preferably, the video creation system, the video creation device, or the video creation program according to the present invention further includes a character viewpoint display unit configured to display an image in which the virtual space is captured from a viewpoint of the character.

The video creation system, the video creation device, or the video creation program of the mode including the character viewpoint display unit enables a person who moves a character to be immersed inside the virtual space and to input a more realistic action by using the character viewpoint display unit. VR goggles can be suitably used for such a character viewpoint display unit.

Using the video creation system, the video creation device, or the video creation program according to the present invention enables creation of a video which does not make a viewer get bored.

### BRIEF DESCRIPTION OF DRAWINGS

FIG. 1 is a diagram illustrating an overall configuration of a video creation system according to an embodiment of the present invention.

FIG. 2 is a diagram illustrating a main configuration of a director device and a performer device included in the video creation system according to the present embodiment.

FIG. 3 is an example of a screen to be displayed on a display unit of the director device in the present embodiment.

FIG. 4 is an example of a scene and disposition of virtual cameras in the present embodiment.

FIGS. 5A to 5C are pictures illustrating a configuration of a video crated in the present embodiment.

### DETAILED DESCRIPTION

An embodiment of a video creation system, a video creation device, and a video creation program according to the present invention will be described below with reference to the drawings. A theatrical-role-play-recording video creation system of the present embodiment is used to shoot a movie by causing a character imitating a real actor to act in a virtual space simulating a real space.

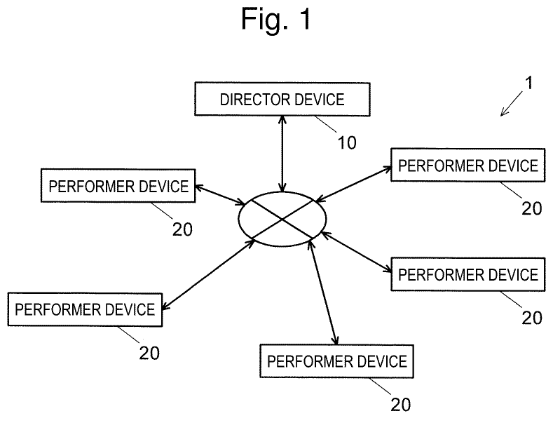

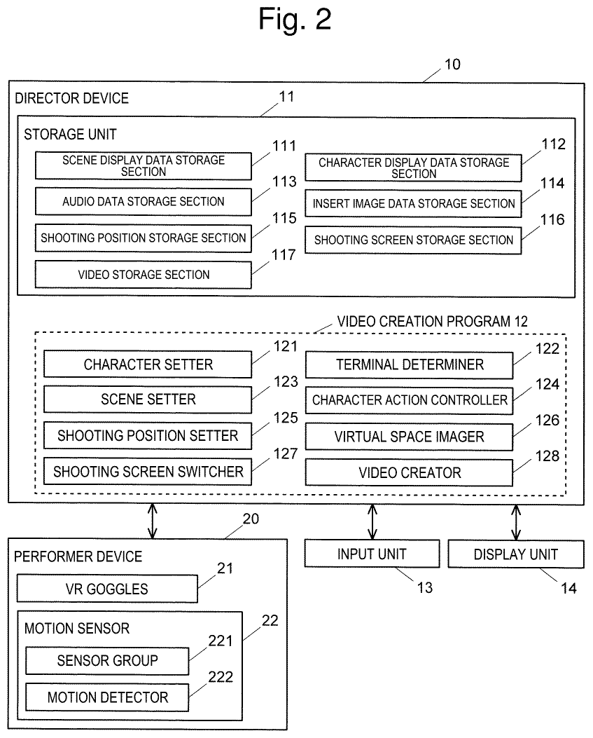

As illustrated in FIGS. 1 and 2, a video creation system 1 according to the present embodiment mainly includes a director device 10 (which corresponds to the video creation device in the present invention) and a plurality of performer devices 20. The director device 10 and the performer devices 20 are connected to each other via a network. FIG. 1 illustrates five performer devices 20, and FIG. 2 illustrates only one performer device 20, but the number of the performer devices 20 can be changed as appropriate.

FIG. 2 illustrates a main configuration of the director device 10 and the performer device 20. When a movie is produced as in the present embodiment, the director device 10 is used by, for example, a movie director or a camera operator. In the following description, a person who creates a video using the director device 10 is referred to as “director”.

The director device 10 includes a storage unit 11. The storage unit 11 includes a scene display data storage section 111 in which display data of one or a plurality of scenes usable in a movie, a drama, an advertisement video, or the like associated with the name of the one or the plurality of scenes is stored, a character display data storage section 112 in which display data of one or a plurality of characters associated with the name of the one or the plurality of characters is stored, an audio data storage section 113 in which music data such as background music or data such as sound effects is stored, an insert image data storage section 114 in which data of an image or a video to be inserted into a video is stored, a shooting position storage section 115 in which information regarding a shooting position of a virtual space and a shooting position of each character are stored for each scene, a shooting screen storage section 116 in which a screen shot by a virtual camera (to be described later) is stored, and a video storage section 117 in which a created video is stored. Moreover, the storage unit 11 stores information of various video effects, which are called effects in the field of video creation.

The scene display data stored in the scene display data storage section 111 may include a plurality of pieces of display data related to the same space. For example, the scene display data may include display data of a temple during the day and a temple during the night, a classroom of a school in which a teacher and students (what is called supporting characters who are other than a character performed by a performer) are present and a classroom of a school in which no student is present, a landscape in which there is no person and a crowd scene (a landscape including supporting characters), and the like. Regarding the presence or absence of supporting characters, the display data of the virtual space including supporting characters and the display data of the virtual space not including supporting characters may be stored as independent display data, or the display data of a virtual space not including supporting characters and the display data of only the supporting characters may be stored and when the use of the latter is selected, both may be displayed in a superimposed manner. In addition, the display data of the supporting characters may be a still image or may have a predetermined motion (for example, students talking and laughing in a classroom, a large number of people walking on a crosswalk, and the like). In addition, the supporting characters in the present embodiment are not limited to humans or animals, and may include, for example, the sun, the stars, the moon, and the like moving at a constant speed in the sky.

In addition, the director device 10 has a character setter 121, a terminal determiner 122, a scene setter 123, a character action controller 124, a shooting position setter 125, a virtual space imager 126, a shooting screen switcher 127, and a video creator 128 as its functional blocks. An entity of the director device 10 may be a general personal computer, and the functional blocks are embodied by a processor executing a video creation program 12 installed in advance. The director device 10 is connected with an input unit 13 including a keyboard, a mouse, and the like and a display unit 14 such as a liquid crystal display. Alternatively, when the director device 10 is of a touch panel type, the director device 10 includes a display serving as both the input unit 13 and the display unit 14.

The performer device 20 is a terminal used by a performer such as an actor who plays and moves a character appearing in a movie. The performer device 20 includes VR goggles 21 (which corresponds to a character viewpoint display unit in the present invention) and a motion sensor 22 (which corresponds to an action input terminal in the present invention). The motion sensor 22 includes a plurality of sensors 221 (sensor group) to be attached to the performer on the performer's predetermined positions and a motion detector 222 for detecting the motion of the plurality of sensors 221. The plurality of performer devices 20 each have a discrimination number for discriminating each of the performer devices 20.

The following describes the procedure of shooting a movie in the video creation system of the present embodiment. Data necessary for producing a video is created and stored in advance, such as display data of each scene stored in the scene display data storage section 111, display data of a character stored in the character display data storage section 112, data of music and sound effects stored in the audio data storage section 113, and data of an image and a video for insertion stored in the insert image data storage section 114.

First, a director logs in to the director device 10 from a terminal used by the director, and performs a predetermined input operation to instruct the start of the movie production.

When the director instructs the start of the movie production, the character setter 121 causes the display unit 14 to display a list of character names stored in the character display data storage section 112. When the director selects a character to appear in a movie to be shot from the displayed list, the character setter 121 reads information on the selected character from the character display data storage section 112. Here, the character selected by the director may include two types of characters which are a player character (a character played by a performer) and a non-player character (a character the action of which is controlled by the director or the like). The non-player character is, for example, a supporting role which appears only in a part of a video to be shot.

In addition, the director also selects data necessary for producing a video from data of music and sound effects stored in the audio data storage section 113, and selects data to be used for the video production from data of insert images and videos stored in the insert image data storage section 114.

Then, the terminal determiner 122 causes the display unit 14 to display, on the screen, the list of player characters read by the character setter 121 and the list of the performer devices 20 connected to the director device 10. When the director performs an operation of associating each performer device 20 with a corresponding player character displayed on the display unit 14, the terminal determiner 122 stores information associating the player character with each performer device 20 in the storage unit 11.

When the director device 10 performs the operations described above, the director device 10 transmits information on the player character associated with the respective performer devices 20 to the performer devices 20. The information transmitted to the performer devices 20 includes at least the name of the player character. In addition, when a script related to the player character is prepared in advance, information on the script may also be included.

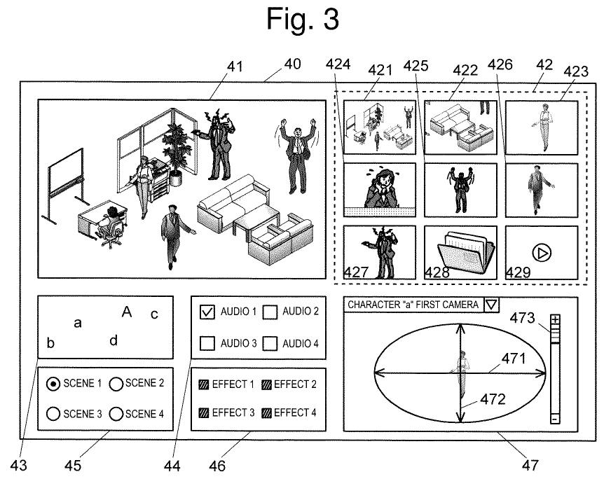

After that, when the director gives an instruction to start shooting by a predetermined input operation, a director screen 40 as illustrated in FIG. 3 is displayed on the display unit 14.

The director screen 40 includes a shooting screen display section 41, a virtual camera image display section 42, a scene overview display section 43, an audio selector section 44, a scene selector section 45, an effect selector section 46, and an angle-of-view adjuster section 47.

The shooting screen display section 41 displays an image of the virtual space acquired at the shooting position selected by the director by the operation described below. The virtual camera image display section 42 displays individual screens taken by a plurality of virtual cameras disposed within the virtual space during shooting and displays image shots.

The image shots are, for example, videos (for example, an opening video, an ending video, a video of a reminiscence scene, and the like) inserted into a movie being shot or images of items or the like which play an important role in each scene. As described above, these videos and images have been created in advance by a director or the like and stored in the insert image data storage section 114.

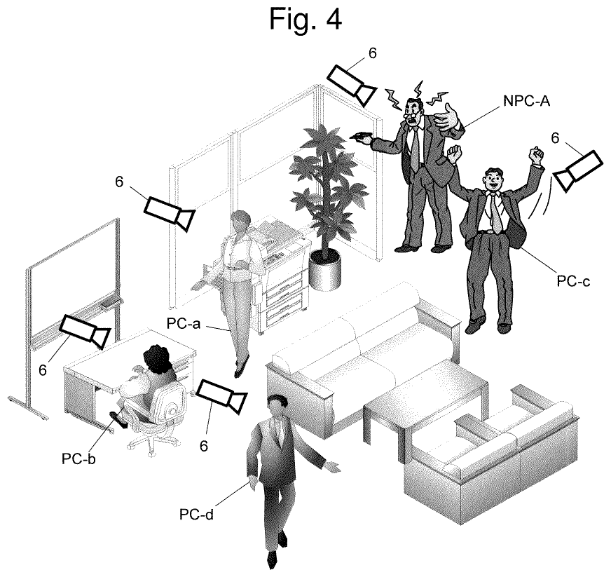

The positions at which the virtual cameras are disposed include a position (entire view position) at which the entire view of the virtual space is captured and a position (character-capturing position) at which an individual character (player character and non-player character) is captured in a close-up manner. As illustrated in FIG. 4, the character-capturing position is a position at which a target character is captured at a predetermined angle of view by a virtual camera 6, and the character-capturing position changes as the character moves. In FIG. 4, only one virtual camera is illustrated for each character. However, for example, a plurality of virtual cameras may be provided to capture a character which is a main character of a movie or a character which plays an important role in each scene at different angles of view. Note that, before or during shooting, the director can select a target virtual camera and change the angle of view through the angle-of-view adjuster section 47 to change the angle of view of the virtual camera (angle of view for capturing the virtual space and angle of view for capturing each character) as appropriate.

In the present embodiment, the following portions are displayed in the virtual camera image display section 42: an entire view image display portion 421 for displaying an image in which the entire view of the virtual space is captured with a wide-angle lens from the entire view position; a standard image display portion 422 for displaying an image in which the virtual space (for example, a space including a center position in the scene or a space in which the characters are mainly located in the scene, such as a sofa in the example of FIG. 3) is captured at a predetermined angle of view with a standard lens from the entire view position; character image display portions 423 to 427 (character image display portions 423 to 426 that display images of player characters a, b, c, and d, and a character image display portion 427 that displays an image of a non-player character A) for displaying images in which the characters (player character and non-player character) are captured from their respective character-capturing positions; and image shot display portions 428 and 429 (an insert image 428 and an insert video 429) for displaying image shots. Note that the number of the character image display portions 423 to 427 is appropriately changed according to the number of player characters and non-player characters appearing in the scene and the number of character-capturing positions of each character. In addition, the number of the image shot display portions 428 and 429 can also be appropriately changed according to the number of images and videos required for the scene. Although the virtual camera image display section 42 displays an original image acquired at each position, it may display, instead of displaying the original image, information (image information, text information, and the like) that can discriminate the shooting position and the shooting target at the respective shooting positions.

The scene overview display section 43 displays a plan view showing the position of each character in the virtual space of the scene being developed. The audio selector section 44 displays a list of music (background music or the like) and sound effects stored in advance in the audio data storage section 113. The scene selector section 45 displays a list of scenes stored in the scene display data storage section 111. The effect selector section 46 displays a list of various video effects. The video effect is what is called effect in the field of video creation, and various types of video effects conventionally known in the field can be used.

The angle-of-view adjuster section 47 displays the name of the virtual camera (such as a first camera of the player character a) selected by the director, the current angle of view of the virtual camera, and operation buttons for changing the angle of view. The angle-of-view adjuster section 47 has a pull-down menu, and operating the pull-down menu allows the director to select a virtual camera the angle of view of which is to be adjusted in the angle-of-view adjuster section 47.

In the present embodiment, as the operation buttons, a horizontal movement part 471 that moves the position of the virtual camera in the left-right (typically horizontal) direction, a vertical movement part 472 that moves the position of the virtual camera in the up-down (typically vertical) direction, and an enlargement factor changing part 473 that changes the enlargement factor are displayed. The angle of view of the virtual camera may be changed by operating a cursor in the angle-of-view adjuster section 47 with a mouse, or may be changed by pressing keys of upper, lower, left, and right keys of a keyboard or numeric keys with which the movement and zooming in/out of the virtual camera have been associated in advance. In addition, instead of the angle-of-view adjuster section 47 of the present embodiment, the angle of view of the virtual camera may be adjusted by numerically inputting the three-dimensional position and the enlargement factor of the virtual camera in the virtual space.

The performers such as actors who move the player characters wear the VR goggles 21 and wear the sensors 221 at a plurality of predetermined positions of their body during shooting. During shooting, the character action controller 124 of the director device 10 transmits, to the performer devices 20, data of an image of the virtual space viewed from the viewpoint of the respective player characters associated with the corresponding performer devices 20 including the VR goggles 21 and causes the VR goggles 21 to display the image. Each performer can act with more immersed feelings by checking the virtual space through the VR goggles 21.

In addition, the director (or assistant of the director) controls the action of the non-player character through the input unit 13 such as a keyboard and a mouse. The action of the non-player character is associated with a predetermined button of a keyboard or an operation of a mouse in advance. In the present embodiment, the director uses the input unit 13 to input the action of the non-player character, but a second input unit for inputting the action of the non-player character may be provided separately from the input unit 13. As the second input unit, for example, a unit similar to the motion sensor 22 included in the performer device 20 can be used.

During shooting, when the performer moves the body, the motion detector 222 detects the motion of each of the plurality of sensors 221 attached to the body of the performer, and transmits movement information of each sensor to the director device 10. In the director device 10, the character action controller 124 causes the player character to move in the virtual space on the basis of the received information. In addition, the character action controller 124 updates the information on the field of view of the player character on the basis of the position and the direction of the line of sight of the player character after the movement, and transmits the updated information to the performer device 20. Furthermore, in response to a predetermined input operation through the input unit 13, the character action controller 124 causes the non-player character to move in the virtual space.

When the director selects a scene (for example, scene 1) to be shot from the list of scenes displayed in the scene selector section 45, the scene setter 123 reads the display data of the corresponding scene from the scene display data storage section 111. Each scene is associated with information of an initial shooting image in the scene (for example, entire view image), and the shooting position setter 125 sets the position as the entire view position. Furthermore, the virtual space imager 126 acquires data of an entire view image obtained by shooting the virtual space with a virtual camera having a wide-angle lens from the entire view position and data of a standard image obtained by shooting the virtual space with a standard lens from the entire view position. The data of the two images (the entire view image and the standard image) acquired at the entire view position is stored in the shooting screen storage section 116 of the director device 10. In addition, the entire view image is displayed on the entire view image display portion 421, and the standard image is displayed on the standard image display portion 422.

When each performer instructs the start of acting (action of the player character) by a predetermined input operation to the performer device 20, the character action controller 124 reads the display data of the player character from the character display data storage section 112 and causes the player character to be displayed at a predetermined position in the current scene. After that, when the performer starts acting, the motion detector 222 detects the motion of the sensors attached to the body of the performer and transmits motion data to the director device 10, and the character action controller 124 causes the character to move in the virtual space on the basis of the motion data. In addition, when the director or the assistant instructs the non-player character to appear by a predetermined input operation through the input unit 13, the character action controller 124 reads the display data of the non-player character from the character display data storage section 112, and causes the non-player character to appear in the current scene.

In addition, at the same time as each character being displayed in the virtual space, the shooting position setter 125 sets the character-capturing position at which each character is captured at a predetermined angle of view. After the shooting has started, the shooting position setter 125 moves the character-capturing position in accordance with the movement of the player character and the non-player character. For each character, the virtual space imager 126 acquires data of an image of the target character captured from the character-capturing position. In addition, the data of the image obtained by shooting each character is stored in the shooting screen storage section 116 and displayed on the character image display portions 423 to 427.

At the start of shooting, an initial setting image (entire view image in the present embodiment) is displayed on the shooting screen display section 41 of the display unit 14 of the director device 10. Simultaneously with the start of the shooting, the video creator 128 begins to sequentially store data of the image displayed in the shooting screen display section 41 in the video storage section 117. In addition, the video creator 128 also sequentially stores images taken at predetermined intervals of time by the virtual cameras disposed at their respective shooting positions in the shooting screen storage section 116 as reference images.

The director prompts the performers to act their characters according to the content of the setting for each scene. When the director and the performers are at the same place, the director notifies the performers of the start and end of shooting by uttering a voice for the start and end of shooting. When the director and the performers are at different places, the performers may be notified by, for example, superimposing a countdown before shooting start and a sign of shooting end on a screen displayed on the VR goggles 21 worn by each performer in response to a predetermined input operation by the director. Alternatively, the performers may be notified by a voice emitted by the director for shooting start or shooting end through a microphone worn by the director, and the instruction may be heard through an earphone or the like worn by the performers.

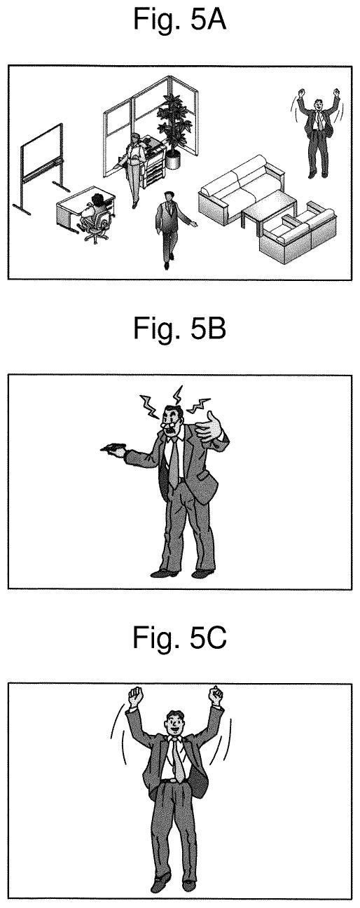

The director selects a character image display portion (any one of 423 to 427) of any of the characters (player character or non-player character) from the virtual camera image display section 42 through the input unit 13 along with the progress of the scenario. Then, the shooting screen switcher 127 causes the shooting screen display section 41 of the display unit 14 of the director device 10 to display the selected image. As described above, when one of the images in the virtual camera image display section 42 is selected by the director, the shooting screen switcher 127 changes the display of the shooting screen display section 41 to the image selected by the director. For example, as illustrated in FIGS. 5A to 5C, an entire view image in which the entire scene is captured is displayed at the start (FIG. 5A), and then the images are switched to shooting screens (FIGS. 5B and 5C) in which a character to be focused at each occasion is captured in a close-up manner in accordance with the progress of shooting.

When the director switches the shooting screen as described above, the video creator 128 stores the data of the shooting screen after switching (image acquired by the virtual camera at the selected position) in the video storage section 117. In addition, the director appropriately changes the angle of view of the shooting screen through the angle-of-view adjuster section 47 as necessary as well as switching the shooting screens. The angle-of-view adjuster section 47 allows the director to adjust both the angles of view of the virtual camera currently acquiring the image displayed on the shooting screen display section 41 and of the other virtual cameras. When the virtual camera being selected at the angle-of-view adjuster section 47 is acquiring the image displayed on the shooting screen display section 41, the angle of view of the virtual camera changed at the angle-of-view adjuster section 47 is immediately reflected in the image on the shooting screen display section 41.

The director causes the non-player character to appear in the virtual space at an appropriate timing during shooting and to appear together with the player character. In addition, the director selects appropriate audio data using the audio selector section 44 and adds audio data (background music or sound effects) to the video, and selects an appropriate effect using the effect selector section 46 and adds a video effect to the video. Furthermore, the director selects images and videos displayed on the image shot display portions 428 and 429, and appropriately inserts the images and the videos into the video. The audio data, the effect, and the insert images and videos are sequentially stored in the video storage section 117 at the timing when they are selected.

When the director performs a predetermined input operation indicating end of video shooting, the video creator 128 creates a video using the data of the images sequentially stored in the video storage section 117 during the shooting procedure, and displays a screen indicating end of video creation on the display unit 14.

Note that the video creator 128 may store those data as image files, video files or in other formats. For example, data of images acquired by the virtual cameras may be prepared in the form of a file in which the position information and posture information of the player characters and the non-player characters within the virtual space at each point in time are associated with the information of the virtual camera selected at that point in time (data file in this format is hereinafter referred to as “parameter data file”), and this parameter data file may be stored in the shooting screen storage section 116 and the video storage section 117 at predetermined intervals of time. In summary, the data of the play-recording video may be stored in an appropriate file format which contains necessary information for forming an image at each point in time. Generating the image data and the video data in the parameter-data-file format can reduce the data volume as compared to the image-file format or the video-file format.

In the present embodiment, a video is created in real time as described above, and the director can immediately check the created video. In addition, in the video creation system 1 of the present embodiment, data of a shooting screen (an image acquired by the virtual camera at the selected position) is sequentially stored in the video storage section 117, and images captured by the virtual cameras disposed at the respective positions are also sequentially stored in the shooting screen storage section 116 as reference images. Thus, the director can appropriately edit the video using these reference images as necessary. In addition, at the time of editing the video, the director can also add audio stored in the audio data storage section 113, add an insert image or an insert video stored in the insert image data storage section 114, or add an effect.

When a video file is created in the parameter-data-file format, the director can easily change the position and the posture of a target (e.g., character) as appropriate or change the setting of the virtual camera (e.g., switch to another virtual camera or change the angle of view) by merely modifying the parameters included in the file.

Since the conventional video creation device uses only one virtual camera in shooting the action of characters in a virtual space, the resulting video becomes monotonous with the characters captured at a single angle of view, and the viewer gets bored while watching the video. Using a plurality of virtual cameras for shooting a produced video can obtain a plurality of images having different angles of view. However, in order to finally create a single video, it is necessary to check a large number of videos obtained by a plurality of virtual cameras each shooting the virtual space simultaneously and select desired portions, and combine them, which takes time and effort.

In the video creation system 1 of the present embodiment, the director causes the player character to act in the virtual space by having the actor act according to the preset script and selects a position (entire view position or character-capturing position) at which the action of the character is most effectively captured at each point in time. By only doing this, the director can easily create a video in which an image acquired by the virtual camera disposed at the position is sequentially recorded.

The previously described embodiment is a mere example and can be appropriately changed or modified according to the gist of the present invention. In the above embodiment, a case where a movie is shot using the video creation system 1 has been described, but any type of video may be shot and an advertisement video or an animation can also be created. In addition, the virtual space may be a space simulating a real space or a non-real space. Furthermore, the character may be a character imitating a famous person such as an actor or an idle who actually exists, or may be a non-existent character. Furthermore, the player character and the non-player character are not limited to humans, and may be animals, robots, or various personified characters.

For example, an existing facility such as a school, a hospital, or a hotel is set as the virtual space, the persons involved in the facility are set as player characters and made to wear the performer devices 20, and students of the school, patients of the hospital, guests of the hotel, or the like are set as non-player characters. With these settings, it is possible to perform evacuation drill assuming a case where a fire, an earthquake, or the like occurs in the facility. In that case, the performers are not informed of the script or the scenario in advance. The director plays a sound effect or causes an unexpected event (explosion of combustible gas, spread of fire in the space) to occur in the virtual space at an appropriate timing, which allows the persons involved to perform the evacuation drill with realistic feeling or sense of urgency. Then, by selecting an image in which a player character performed by a person who has taken a marked action in the evacuation drill is captured as a shooting video, it is possible to confirm items to be noted at the time of the evacuation drill or use the shooting video as an educational video.

In the above embodiment, the performer device 20 includes the VR goggles 21 and the motion sensor 22, but it can include other devices. For example, instead of the VR goggles 21 and the motion sensor 22, VR goggles having a function of the motion sensor may be used. In addition to the function of displaying the virtual space from the viewpoint of the player character, the VR goggles 21 may have a function of detecting the facial expression of the performer and reflecting the facial expression on the face of the player character in the virtual space. Alternatively, instead of the VR goggles 21, a monitor for displaying an image in which the virtual space is captured from the viewpoint of the player character, similarly to the VR goggles 21 in the above embodiment, can be used. In addition, for example, instead of the motion sensor 22, a controller in which a relationship between an action of the player character and a button is defined in advance, or the like can be used. Note that, when a video in which a single performer plays the player character and has it dance or the like is shot, the performer does not necessarily check the state of the virtual space, and thus the display unit such as the VR goggles 21 may not be provided.

In addition, a microphone to be worn by the performer may be added to the performer device 20 of the above embodiment and the voice uttered by the performer through the microphone may be recorded as audio data to create a video in which data of the shooting image and the audio data are combined. Alternatively, the voice of the performer may be recorded in advance and stored in the audio data storage section 113 as data, and the voice of the performer may be selected during shooting and added to the video, or the voice may be added at the editing of the video after the video shooting.

In the above embodiment, the director selects a scene which the director intends to shoot from among the scenes stored in the scene display data storage section 111, selects a character to appear in a video from among the characters stored in the character display data storage section 112, and selects an image or a video to be used by the director from among the pieces of data of insert images and videos stored in the insert image data storage section 114. However, another mode can be adopted. For example, a list of videos to be shot is created, and each video is associated with a scene to be used for shooting the video, characters to appear in the video, and data of images and videos to be inserted into the video and stored as a single package. This configuration allows the director to collectively select the scene, the characters, and the insert images and videos only by selecting a single package.

Some or all of the functions of the storage unit and the functional blocks included in the director device 10 of the above embodiment may be provided in another computer (for example, a cloud server) connectable to the director device 10 and the performer device 20. For example, when the function of the director device 10 of the above embodiment is provided in a cloud server, it is possible to configure each functional block in the cloud server to operate in accordance with an input from the director device 10 and the performer device 20, and the created image file or video file to be downloaded from the storage unit of the cloud server to the director device 10.

### REFERENCE SIGNS LIST

1 . . . . Video Creation System
10 . . . . Director Device
11 . . . . Storage Unit
111 . . . . Scene Display Data Storage Section
112 . . . . Character Display Data Storage Section
113 . . . . Audio Data Storage Section
114 . . . . Insert Image Data Storage Section
115 . . . . Shooting Position Storage Section
116 . . . . Shooting Screen Storage Section
117 . . . . Video Storage Section
12 . . . . Video Creation Program
121 . . . . Character Setter
122 . . . . Terminal Determiner
123 . . . . Scene Setter
124 . . . . Character Action Controller
125 . . . . Shooting Position Setter
126 . . . . Virtual Space Imager
127 . . . . Shooting Screen Switcher
128 . . . . Video Creator
13 . . . . Input Unit
14 . . . . Display Unit
20 . . . . Performer Device
21 . . . . VR Goggles
22 . . . . Motion Sensor
221 . . . . Sensor
222 . . . . Motion Detector
40 . . . . Director Screen
41 . . . . Shooting Screen Display Section
42 . . . . Virtual Camera Image Display Section
421 . . . . Entire View Image Display Portion
422 . . . . Standard Image Display Portion
423 to 427 . . . . Character Image Display Portion
428, 429 . . . . Image Shot Display Portion
43 . . . . Scene Overview Display Section
44 . . . . Audio Selector Section
45 . . . . Scene Selector Section
46 . . . . Effect Selector Section
47 . . . . Angle-of-View Adjuster Section
6 . . . . Virtual Camera

1. A video creation system for creating a video of a character acting in a virtual space, the video creation system comprising:
a storage unit configured to store display data of a virtual space and display data of a character;
an action input terminal configured to allow a user to input an action of the character;
a character action controller configured to read the display data of the character from the storage unit and cause the character to act in the virtual space according to the action of the character input to the action input terminal;
a shooting position setter configured to set an entire view position at which an entire view of the virtual space is captured and a character-capturing position at which the character in the virtual space is captured at a predetermined angle of view;
a shooting position selector configured to receive an input for selecting the entire view position or the character-capturing position as a shooting position;
a virtual space imager configured to generate data of an image obtained by shooting the virtual space with a virtual camera at the shooting position input to the shooting position selector; and
a video creator configured to create data of a video by sequentially recording the data of images obtained by the virtual space imager.

2. The video creation system according to claim 1, further comprising a shooting image display unit configured to display an image of the virtual space captured by the virtual camera at the entire view position and an image of the virtual space captured by the virtual camera at the character-capturing position.

3. The video creation system according to claim 1, further comprising
a character viewpoint display unit configured to display an image in which the virtual space is captured from a viewpoint of the character.

4. The video creation system according to claim 1, further comprising
an angle-of-view adjuster section configured to adjust an angle of view at which a target is captured by the virtual camera at the entire view position and/or the character-capturing position.

5. A video creation device for creating a video of a character acting in a virtual space, the video creation device connectable to an action input terminal configured to allow a user to input an action of the character, the video creation device comprising:
a storage unit configured to store display data of a virtual space and display data of a character;
a character action controller configured to read the display data of the character from the storage unit and cause the character to act in the virtual space according to the action of the character input to the action input terminal;
a shooting position setter configured to set an entire view position at which an entire view of the virtual space is captured and a character-capturing position at which the character in the virtual space is captured at a predetermined angle of view;
a shooting position selector configured to receive an input for selecting the entire view position or the character-capturing position as a shooting position;
a virtual space imager configured to generate data of an image obtained by shooting the virtual space with a virtual camera at the shooting position input to the shooting position selector; and
a video creator configured to create data of a video by sequentially recording the data of images obtained by the virtual space imager.

6. A non-transitory computer-readable medium storing a video creation program for creating a video of a character acting in a virtual space, the video creation program configured to cause a computer connectable to an action input terminal configured to allow a user to input an action of the character and including a storage unit configured to store display data of the virtual space and display data of the character to operate as:
a character action controller configured to read display data of a character from the storage unit and cause the character to act in a virtual space according to the action of the character input to the action input terminal;
a shooting position setter configured to set an entire view position at which an entire view of the virtual space is captured and a character-capturing position at which the character in the virtual space is captured at a predetermined angle of view;
a shooting position selector configured to receive an input for selecting the entire view position or the character-capturing position as a shooting position;
a virtual space imager configured to generate data of an image obtained by shooting the virtual space with a virtual camera at the shooting position input to the shooting position selector; and
a video creator configured to create data of a video by sequentially recording the data of images obtained by the virtual space imager.
